(19) United States
(12) Patent Application Publication
(10) Pub. No.: US 2021/0220839 A1
(43) Pub. Date: Jul. 22, 2021

(54) ELECTRIC DUST COLLECTOR

(71) Applicants: FUJI ELECTRIC CO., LTD., Kanagawa (JP); SCHOOL JUDICIAL PERSON IKUTOKU GAKUEN, Kanagawa (JP)

(72) Inventors: Takashi INUI, Hachioji-city (JP); Hiroyuki TOYOZUMI, Hino-city (JP); Akinori ZUKERAN, Tokyo (JP); Soma TOGUCHI, Kanagawa (JP)

(21) Appl. No.: 17/220,950

(22) Filed: Apr. 2, 2021

Related U.S. Application Data
(63) Continuation of application No. PCT/JP2019/035325, filed on Sep. 9, 2019.

(30) Foreign Application Priority Data
Oct. 26, 2018 (JP) 2018-202301

(51) Int. Cl. B03C 3/74; B03C 3/49; H05B 6/68; H05B 6/64

(52) U.S. Cl. CPC B03C 3/74; B03C 3/49; H05B 6/68; B03C 2201/24; H05B 6/645; B03C 2201/12; H05B 6/6447

(57) ABSTRACT

Provided is an electric dust collector comprising a dust collection unit that traps charged particles; and a microwave generation unit that generates a microwave to be introduced into the dust collection unit and combusts the charged particles trapped in the dust collection unit by the microwave.

The contents of the following Japanese patent applications are incorporated herein by reference:

2018-202301 filed in JP on Oct. 26, 2018 and

PCT/JP2019/035325 filed on Sep. 9, 2019.

### BACKGROUND

### 1. Technical Field

The present invention relates to an electric dust collector.

### 2. Related Art

In the related art, known is an electric dust collector that treats an exhaust gas from a Diesel engine and the like (for example, refer to Patent Document 1, 2, 3, 4 and 5). Patent Document 1: Japanese Patent Application Publication No. 2013-188708 Patent Document 2: Japanese Patent Application Publication No. 2012-170869 Patent Document 3: Japanese Patent Application Publication No. 2011-245429 Patent Document 4: Japanese Patent Application Publication No. 2011-252387 Patent Document 5: Japanese Patent Application Publication No. 2016-53341

### Technical Problem

In the electric dust collector, it is preferably to improve energy efficiency. Also, although it is studied to use a DPF (Diesel Particular Filter) for ships, the application of the DPF to ships has not been put to practical use. Also, since the DPF is large and heavy, it is not suitable for ships.

### GENERAL DISCLOSURE

In order to solve the problem, a first aspect of the present invention provides an electric dust collector. The electric dust collector comprises a dust collection unit that traps charged particles, and a microwave generation unit that generates a microwave to be introduced into the dust collection unit and combusts the charged particles trapped in the dust collection unit by the microwave.

The microwave generation unit may include a frequency control unit that changes a frequency of the microwave to combust the charged particles in different positions.

The microwave generation unit may include a polarization control unit that controls a polarization direction of the microwave.

The dust collection unit may include a first electrode and a second electrode. The dust collection unit may trap the charged particles by an electric field that is generated by a potential difference between the first electrode and the second electrode. In the dust collection unit, a position of the electric field that is generated by the potential difference between the first electrode and the second electrode and a position of an electric field that is applied by the microwave may be different.

The microwave generation unit may intermittently generate the microwave. The microwave generation unit may generate the microwave at preset time intervals.

The microwave generation unit may set microwave energy that is generated in a state where the charged particles trapped in the dust collection unit are combusting and decomposed smaller than microwave energy that is generated in a state where the charged particles trapped in the dust collection unit are not combusting. The microwave generation unit may change a time interval at which the microwave is generated or an irradiation time of the microwave. The microwave generation unit may set a pulse width of the microwave that is generated in a state where the charged particles trapped in the dust collection unit are continuously combusting smaller than a pulse width of the microwave that is generated in a state where the charged particles trapped in the dust collection unit are not continuously combusting.

The microwave generation unit may change an output of the microwave. The microwave generation unit may set a pulse amplitude of the microwave that is generated in a state where the charged particles trapped in the dust collection unit are combusting and decomposed smaller than a pulse amplitude of the microwave that is generated in a state where the charged particles trapped in the dust collection unit are not combusting and decomposed.

The microwave generation unit may generate the microwave, based on a trapped state of the charged particles trapped in the dust collection unit.

The electric dust collector may further comprise an elapsed time measuring unit that measures an elapsed time after stopping generation of the microwave. The microwave generation unit may generate the microwave, based on the elapsed time measured by the elapsed time measuring unit.

The electric dust collector may further comprise a particle amount measuring unit that measures an amount of the charged particles trapped in the dust collection unit. The microwave generation unit may generate the microwave, based on the amount of the charged particles measured by the particle amount measuring unit. The electric dust collector may comprise a plurality of the particle amount measuring units.

The charged particles may be generated by charging particles contained in an exhaust gas that is exhausted by a gas source. The dust collection unit may trap the charged particles. The microwave generation unit may generate the microwave, based on a type of fuel of the gas source. The microwave generation unit may control at least one of a time interval at which the microwave is generated, and a frequency and a polarization direction of the microwave, based on the type of fuel of the gas source.

The dust collection unit may include a temperature sensor that detects a temperature of the dust collection unit. The microwave generation unit may generate the microwave, based on a temperature detected by the temperature sensor.

The dust collection unit may include a plurality of temperature sensors arranged in different positions. The microwave generation unit may generate the microwave, based on temperatures detected by the plurality of temperature sensors.

The electric dust collector may further comprise a concentration measuring unit that measures a concentration of at least one of carbon dioxide, oxygen and carbon monoxide in the dust collection unit. The microwave generation unit may generate the microwave, based on a concentration measured by the concentration measuring unit. The electric dust collector may comprise a plurality of the concentration measuring units.

The dust collection unit may further include a catalyst for promoting combustion of the charged particles by the microwave. The catalyst may be provided at a part of the dust collection unit.

The catalyst may be applied on an inner wall of the dust collection unit.

The dust collection unit may further include soot accumulation units that accumulate soot generated as a result of combustion of the charged particles by the microwave. The soot accumulation units may be periodically arranged along a traveling direction of the microwave. An arrangement period of the soot accumulation units may be the same as a period of the microwave.

The summary of the present invention does not necessarily describe all necessary features of the present invention. The present invention may also be a sub-combination of the features described above.

### BRIEF DESCRIPTION OF DRAWINGS

FIG. 1 shows an example of an exhaust gas treatment system 10 in which an electric dust collector 20 in accordance with one embodiment of the present invention is incorporated.

FIG. 2 is a block diagram showing a configuration of the electric dust collector 20 in accordance with one embodiment of the present invention.

FIG. 3 is a conceptual view showing an example of a dust collection unit 22.

FIG. 4 shows an example of an irradiation pattern of a microwave.

FIG. 5 shows another example of the irradiation pattern of the microwave.

FIG. 6 shows absorbed powers in positions P1 to P5 of FIG. 3.

FIG. 7 shows injection energy dependency of a combustion rate of charged particles 28 when the microwave is irradiated intermittently and continuously.

FIG. 8 shows time dependency of concentrations of oxygen (O₂), carbon dioxide (CO₂) and carbon monoxide (CO) that are generated as the charged particles 28 are combusted and decomposed by the microwave.

FIG. 9 shows another example of the irradiation pattern of the microwave.

FIG. 10 shows another example of the irradiation pattern of the microwave.

FIG. 11 shows an example of the electric dust collector 20 in accordance with one embodiment of the present invention.

FIG. 12 shows an example of a configuration of a partition wall 32 (second electrode).

FIG. 13 shows an example of a YZ section in a position X1 in an X-axis direction of FIG. 12.

FIG. 14 shows an example of the YZ section in a position X2 in the X-axis direction of FIG. 12.

FIG. 15 shows another example of the electric dust collector 20 in accordance with one embodiment of the present invention.

FIG. 16 shows another example of the YZ section in the position X2 in the X-axis direction of FIG. 12.

FIG. 17 shows another example of the YZ section in the position X2 in the X-axis direction of FIG. 12.

FIG. 18 shows another example of the YZ section in the position X1 in the X-axis direction of FIG. 12.

FIG. 19 shows an XY section passing an outer wall 39, openings 48, a space 41, openings 38, a first electrode 30 and a partition wall 32 (second electrode) of the dust collection unit 22 in FIGS. 11 and 12.

### DESCRIPTION OF EXEMPLARY EMBODIMENTS

Hereinafter, the present invention will be described through embodiments of the invention. However, the embodiments do not limit the invention defined in the claims. Also, all combinations of features described in the embodiments are not necessarily essential to solutions of the invention.

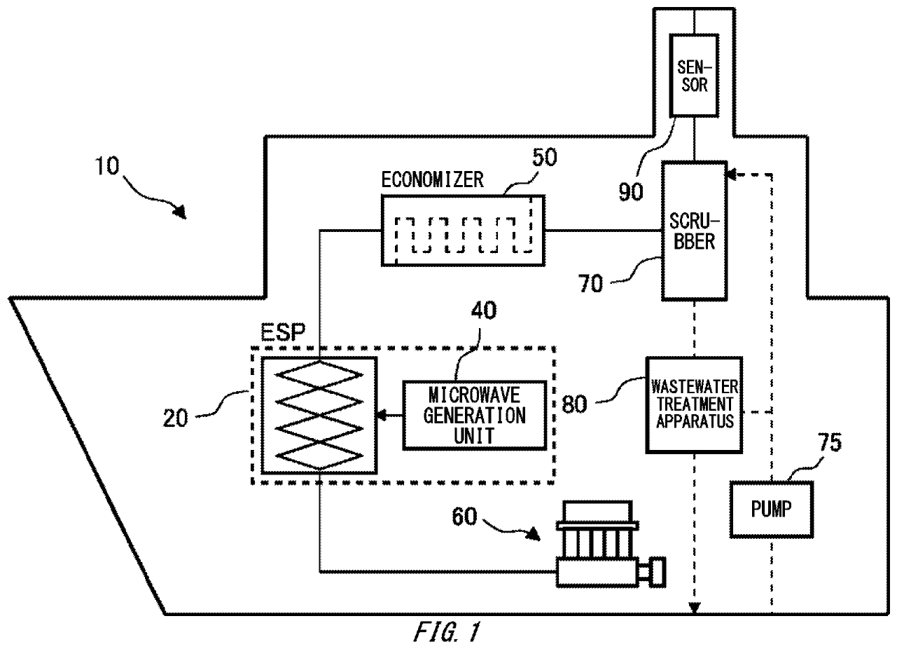

FIG. 1 shows an example of an exhaust gas treatment system 10 in which an electric dust collector 20 in accordance with one embodiment of the present invention is incorporated. The exhaust gas treatment system 10 treats an exhaust gas that is exhausted by an engine 60 of a ship and the like, for example.

The exhaust gas treatment system 10 comprises an electric dust collector (ESP) 20, an economizer 50, an engine 60, a scrubber 70, a wastewater treatment apparatus 80 and a sensor 90. The electric dust collector 20 comprises a microwave generation unit 40.

The engine 60 exhausts the exhaust gas generated as a result of combustion of fuel. The exhaust gas contains substances such as nitrogen oxides (NOx), sulfur oxides (SOx), particle matters (PM) and the like. The particle matter (PM) is also called black carbon, and is generated due to incomplete combustion of fossil fuel. The particle matters (PM) is a fine particle whose main component is carbon.

The exhaust gas exhausted from the engine 60 is supplied to the electric dust collector 20. The electric dust collector 20 removes the particle matters (PM) contained in the exhaust gas.

The economizer 50 exchanges heat of the exhaust gas from which the particle matters (PM) have been removed, thereby generating hot water and steam. The hot water and steam may be used for hot water and heating that are used inboard, respectively. The exhaust gas having passed through the economizer 50 is supplied to the scrubber 70.

The pump 75 pumps up and supplies the seawater to the scrubber 70, for example. The scrubber 70 uses the seawater supplied by the pump 75 as an absorbing liquid, and traps and separates the sulfur oxides and the like in the exhaust gas into droplets of the absorbing liquid. The exhaust gas from which the sulfur oxides and the like have been separated and removed is supplied to the sensor 90.

The sensor 90 measures a predetermined property of the exhaust gas. The predetermined property is concentrations of the sulfur oxides and the like contained in the exhaust gas, for example. The exhaust gas treatment system 10 may control a praying amount of the seawater in the scrubber 70, and the like, based on a measurement result of the sensor 90.

The absorbing liquid in the scrubber 70 is supplied to the wastewater treatment apparatus 80. The wastewater treatment apparatus 80 removes the sulfur oxide and the like included in the absorbing liquid, and then discharges the absorbing liquid to an outside (for example, the sea) of the exhaust gas treatment system 10.

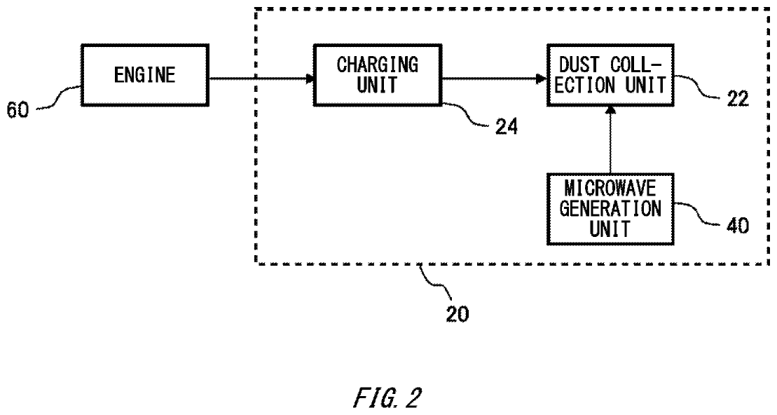

FIG. 2 is a block diagram showing a configuration of the electric dust collector 20 in accordance with one embodiment of the present invention. The electric dust collector 20 comprises a dust collection unit 22, a charging unit 24 and a microwave generation unit 40. The charging unit 24 is supplied with the exhaust gas exhausted from the engine 60. The exhaust gas contains the particle matters (PM). The charging unit 24 generates negative ions by negative corona discharge, for example, and charges the particle matters (PM) to generate charged particles. The charged particles are sent to the dust collection unit 22.

The dust collection unit 22 traps the charged particles. The dust collection unit 22 has a member arranged on a path through which the exhaust gas passes and applied with a ground potential, for example, thereby trapping the charged particles by Coulomb force, for example.

The microwave generation unit 40 generates a microwave that is introduced into the dust collection unit 22. The microwave is an electromagnetic wave having a frequency of about 300 MHz to 300 GHz.

In the present example, the electric dust collector 20 combusts the charged particles trapped in the dust collection unit 22 by the microwave generated by the microwave generation unit 40. In general, a heating rate Q of a to-be-heated object by the microwave is expressed by a following equation. Q=(½)σ|E|²+(½)ωε″|E|²+(½)ω″|B|²

The first term (½)σ|E|² indicates a heating rate by Joule heating by an electric field. Here, σ indicates conductivity of fine particles contained in the to-be-heated object. Also, E is an electric field by the microwave. The applying of the electric field to the to-be-heated object causes movement of charges in the to-be-heated object. The movement of charges, i.e., current causes Joule loss. The first term indicates heat generation due to Joule loss.

The second term (½)ωε″|E|² indicates a heating rate by dielectric heating by an electric field. Here, ω indicates an angular frequency of the microwave, and ε″ indicates an imaginary part of a dielectric constant of the to-be-heated object. When an electric field is applied to the to-be-heated object, the electric dipole contained in the to-be-heated object follows a change in the electric field with a time delay. The following of the electric dipole with a time delay causes loss. The second term indicates heat generation due to the loss.

The third term (½)ωμ″|E|² indicates a heating rate by Joule heating by eddy current. Here, μ″ is an imaginary part of a magnetic permeability of the to-be-heated object. When a magnetic field is applied to the to-be-heated object, eddy current is generated in a direction of preventing a change in magnetic field. The eddy current causes Joule loss. The third term indicates heat generation due to the Joule loss.

In the present example, the electric dust collector 20 combusts the charged particles trapped in the dust collection unit 22 by the microwave generated by the microwave generation unit 40. In order to irradiate the microwave to the dust collection unit 22, an antenna for microwave irradiation may be arranged in the electric dust collector 20. For this reason, the electric dust collector 20 of the present example can remove the particle matters (PM) by a simple configuration and in a space saving manner, as compared to methods such as hammering, air cleaning, water cleaning and the like.

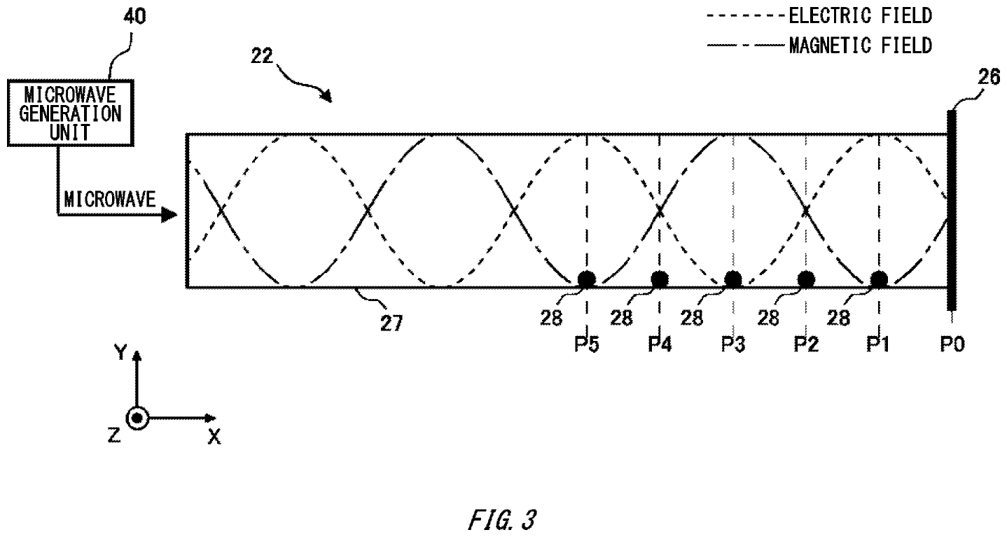

FIG. 3 is a conceptual view showing an example of the dust collection unit 22. In the present example, the dust collection unit 22 has a waveguide shape. In the present example, a traveling direction of the microwave is defined as an X-axis, and an amplitude direction of the microwave is defined as a Y-axis. Also, a direction perpendicular to both the X-axis and the Y-axis is set as a Z-axis.

The microwave generated by the microwave generation unit 40 is introduced from one end of the dust collection unit 22 in the X-axis direction. An inner wall of the dust collection unit 22 is formed of a material capable of reflecting the microwave. Also, the other end of the dust collection unit 22 in the X-axis direction is provided with a reflection plate 26 for reflecting the microwave. The microwave introduced from one end of the dust collection unit travels in the +X-axis direction, is reflected by the reflection plate 26 and travels in the −X-axis direction. In the dust collection unit 22, the microwave traveling in the +X-axis direction and the microwave traveling in the −X-axis direction interfere with each other. As a result, a traveling wave or standing wave is formed in the dust collection unit 22.

In FIG. 3, an electric field component and a magnetic field component of the microwave are denoted with a broken line and a dashed-dotted line, respectively. The electric field component and the magnetic field component of the microwave have a phase difference of 180°.

A position in the X-axis direction in which the reflection plate 26 is arranged is defined as a position P0. Positions in the X-axis direction in which the electric field component of the standing wave shows the maximum and the magnetic field component shows the minimum are defined as a position P1 and a position P5. In the X-axis direction, the position P5 is more distant from the position P0 than the position P1. A position in the X-axis direction in which the electric field component of the standing wave shows the minimum and the magnetic field component shows the maximum is defined as a position P3. In the X-axis direction, a center between the position P1 and the position P3 and a center between the position P3 and the position P5 are respectively defined as a position P2 and a position P4.

A bottom 27 of the dust collection unit 22 is disposed thereon with charged particles 28. In the present example, the charged particles 28 are disposed in the position P1 to the position P5, respectively.

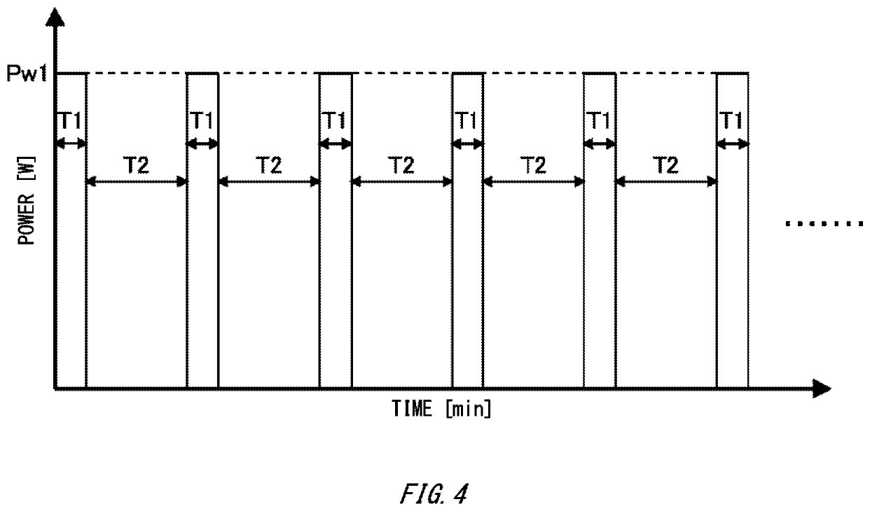

FIG. 4 shows an example of the irradiation pattern of the microwave. FIG. 4 shows an example of an intermittent irradiation pattern of a microwave. In the present example, the intermittent irradiation means repeating continuous irradiation of a microwave of predetermined power for a predetermined time (T1 in FIG. 4) and then stopping the irradiation for a predetermined time (T2 in FIG. 4). T1 and T2 may be different or the same. T1 may be shorter or longer than T2. T2 may be 1.0 times or greater and 5.0 times or less of T1.

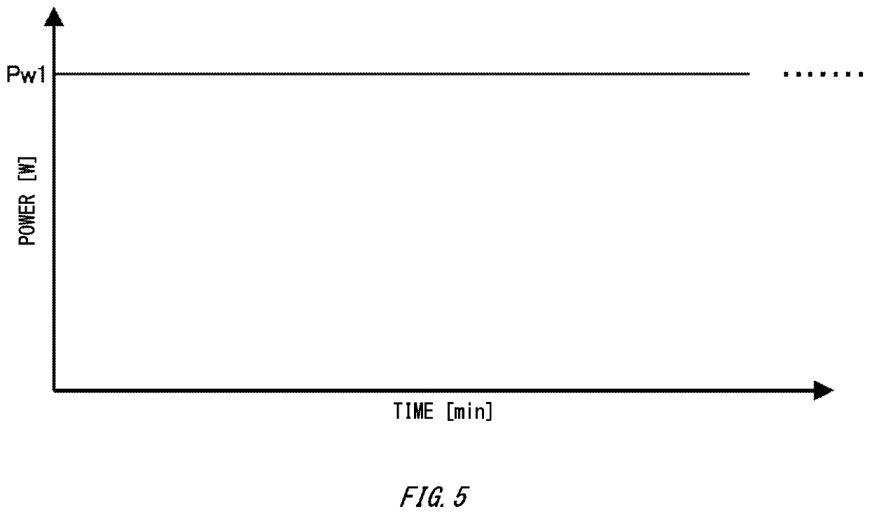

FIG. 5 shows another example of the irradiation pattern of the microwave. FIG. 5 shows an example of a continuous irradiation pattern of the microwave. In the present example, the continuous irradiation means irradiating continuously a microwave of predetermined power without stopping the irradiation for a predetermined time period.

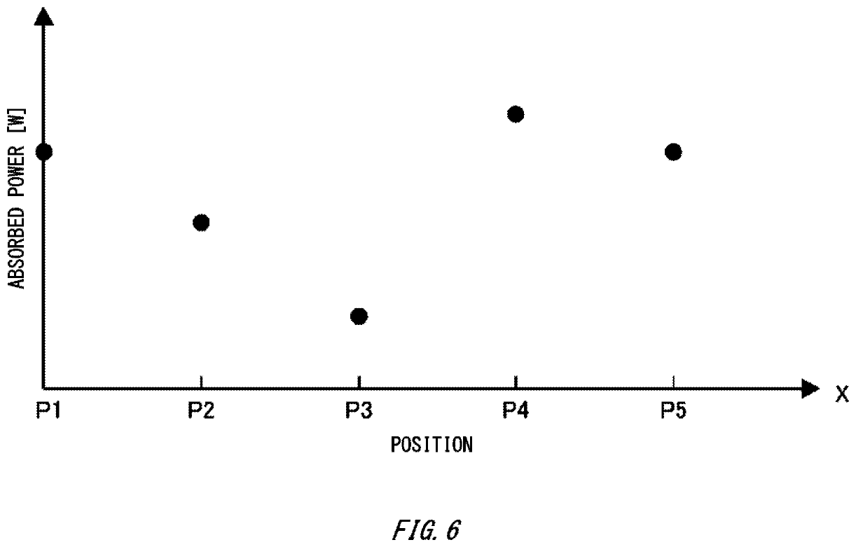

FIG. 6 shows absorbed powers in the positions P1 to P5 of FIG. 3. It can be seen from FIG. 6 that the absorbed power is greater in the position P1 and the position P5 in which the electric field component of the microwave shows the maximum value than in the position P3 in which the magnetic field component of the microwave shows the maximum value. This indicates that a larger amount of the charged particles 28 is combusted in the position P1 and the position P5 in which the electric field component of the microwave shows the maximum value. For this reason, when the charged particles 28 are disposed in positions in which the electric field component of the microwave shows the maximum, it is possible to efficiently combust the charged particles 28.

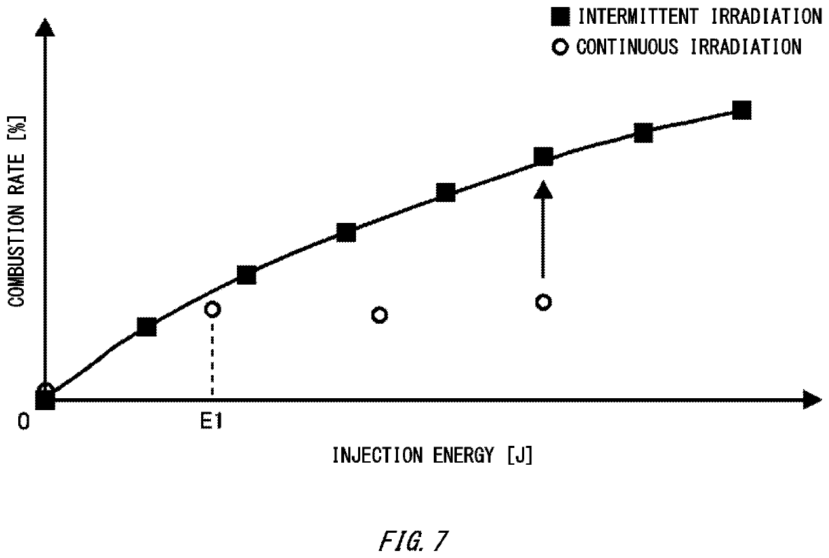

FIG. 7 shows injection energy dependency of a combustion rate of the charged particles 28 in a case when the microwave is irradiated intermittently and continuously. It can be seen from FIG. 7 that when the microwave is continuously irradiated, the combustion rate of the charged particles 28 increases to the injection energy E1 as the injection energy increases. However, the combustion rate of the charged particles 28 does not substantially increase as the injection energy increases, once the injection energy exceeds the injection energy E1. In contrast, when the microwave is intermittently irradiated, the combustion rate of the charged particles 28 increases as the injection energy increases. That is, when the microwave is intermittently irradiated to the charged particles 28, it is possible to reduce the consumption energy necessary for combustion and decomposition of the charged particles 28, as compared to the case where the microwave is continuously irradiated.

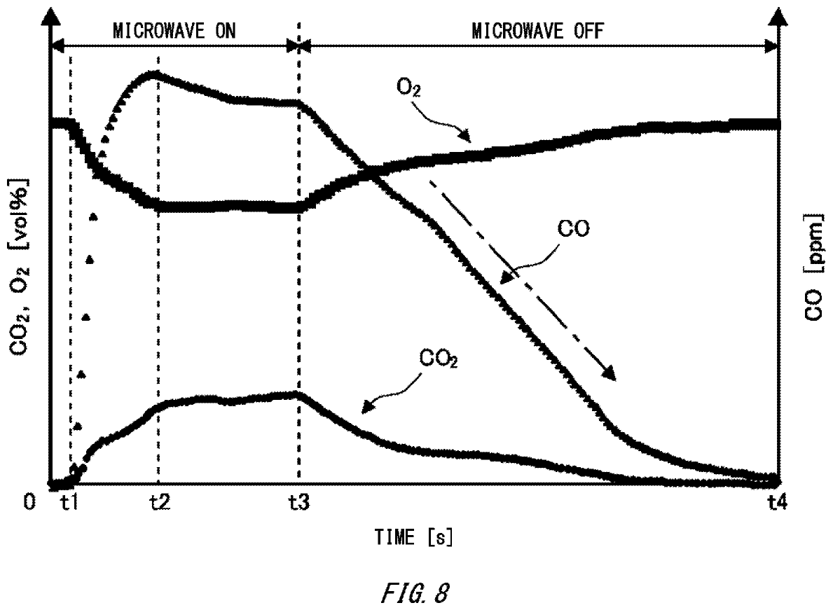

FIG. 8 shows time dependency of concentrations of oxygen (O₂), carbon dioxide (CO₂) and carbon monoxide (CO) that are generated as the charged particles 28 are combusted and decomposed by

the microwave. In the present example, the microwave is turned on at time zero, and the ON state of the microwave ON is maintained up to t3. At time t3, the microwave is turned off, and the OFF state of the microwave is maintained up to t4.

When time elapses from time zero to time t1, the concentration of carbon monoxide (CO) rapidly increases, the concentration of oxygen (O₂) starts to decrease, and the concentration of carbon dioxide (CO₂) starts to increase. This indicates that the charged particles 28 are combined with oxygen (O₂), so that the combustion and decomposition of the charged particles 28 start and generation of carbon monoxide (CO) and carbon dioxide (CO₂) starts. Also, it indicates that the charged particles 28 are incompletely combusted and a larger amount of carbon monoxide (CO) is generated than carbon dioxide (CO₂).

After time t2, the concentration of carbon monoxide (CO) shows a decreasing tendency, and the concentration of oxygen (O₂) and the concentration of carbon dioxide (CO₂) start to change to substantially constant values. This indicates that the combustion and decomposition of the charged particles 28 proceed in a predetermined steady state.

After time t3, the concentration of carbon monoxide (CO) and the concentration of carbon dioxide (CO₂) start to decrease, and the concentration of oxygen (O₂) starts to increase. The concentration of carbon monoxide (CO) gradually decreases even after time t3, as shown with the dashed-dotted line in FIG. 8. This indicates that even after the microwave is turned off, the combustion and decomposition of the charged particles 28 continue. That is, the charged particles 28 are combusted in a chain. From above, it can be seen that even though the microwave is not continuously irradiated to the charged particles 28, it is possible to combust and decompose the charged particles 28.

When time elapses from time t3 to time t4, the concentration of carbon monoxide (CO) and the concentration of carbon dioxide (CO₂) become substantially zero, and the concentration of oxygen (O₂) is recovered to the concentration at time zero. This indicates that the combustion and decomposition of the charged particles 28 are over.

When the microwave is again turned on at time t4, the incomplete combustion of the charged particles 28 again repeats. This corresponds to the intermittent irradiation of FIG. 7. From above, after the combustion and decomposition of the charged particles 28 are performed in the predetermined steady state (from time t2 to time t3 in FIG. 8), when the microwave is turned off to progress the combustion and decomposition of the charged particles 28 and the microwave is again turned on at a timing (time t4 in FIG. 8) at which the combustion and decomposition are over, it is possible to combust and decompose the charged particles 28 while reducing the amount of energy consumption.

Also, after turning off the microwave, the microwave may be turned on before the concentration of carbon monoxide (CO) and the concentration of carbon dioxide (CO₂) become zero. That is, the microwave may be turned on before the combustion and decomposition of the charged particles 28 are over (between time t3 and time t4 in FIG. 8). When the microwave is turned on after the combustion and decomposition of the charged particles 28 are over, the combustion efficiency of the charged particles 28 may be lowered. The microwave is turned on in a state where the charged particles 28 are continuously combusted and decomposed, so that it is possible to continuously combust the charged particles 28 while reducing the amount of energy consumption.

The microwave generation unit 40 may control the on and off states of the microwave, based on at least one of the concentration of carbon monoxide (CO) and the concentration of carbon dioxide (CO₂). For example, the microwave generation unit 40 may turn on the microwave when the concentration of carbon monoxide (CO) becomes below a predetermined threshold value greater than zero after turning off the microwave.

Also, the microwave generation unit 40 may set microwave energy that is generated in a state where the charged particles 28 are continuously combusting and decomposed smaller than microwave energy that is generated in a state where the charged particles 28 are not combusting. A combustion state of the charged particles 28 may be determined, based on at least one of the concentration of carbon monoxide (CO) and the concentration of carbon dioxide (CO₂).

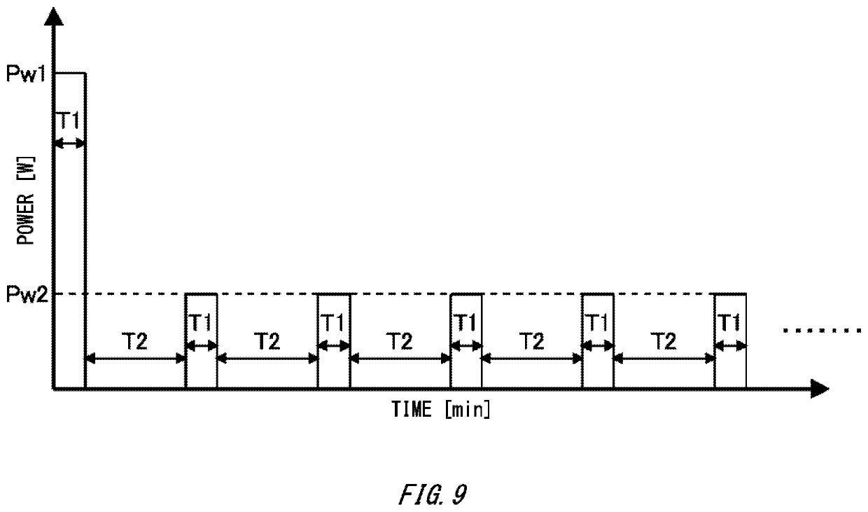

FIG. 9 shows another example of the irradiation pattern of the microwave. The microwave generation unit 40 may change an output of the microwave. That is, when reducing the microwave energy, as with the present example, the microwave generation unit 40 may set a pulse amplitude of the microwave that is generated in a state where the charged particles 28 are not continuously combusting to Pw1, and set a pulse amplitude of the microwave that is generated in a state where the charged particles 28 are continuously combusting to Pw2 smaller than Pw1. Thereby, it is possible to further reduce the amount of energy consumption.

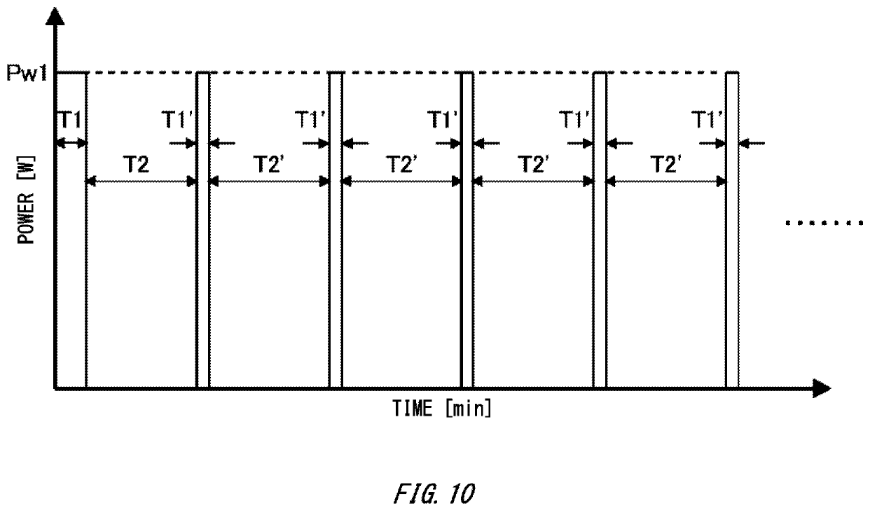

FIG. 10 shows another example of the irradiation pattern of the microwave. The microwave generation unit 40 may change a time interval at which the microwave is generated or an irradiation time of the microwave. That is, when reducing the microwave energy, as with the present example, the microwave generation unit 40 may set a pulse width of the microwave that is generated in a state where the charged particles 28 are not continuously combusting to T1, and set a pulse width of the microwave that is generated in a state where the charged particles 28 are continuously combusting to T1′ smaller than T1. Thereby, it is possible to further reduce the amount of energy consumption. Also, the microwave generation unit 40 may reduce one or both of the pulse amplitude and the pulse width of the microwave.

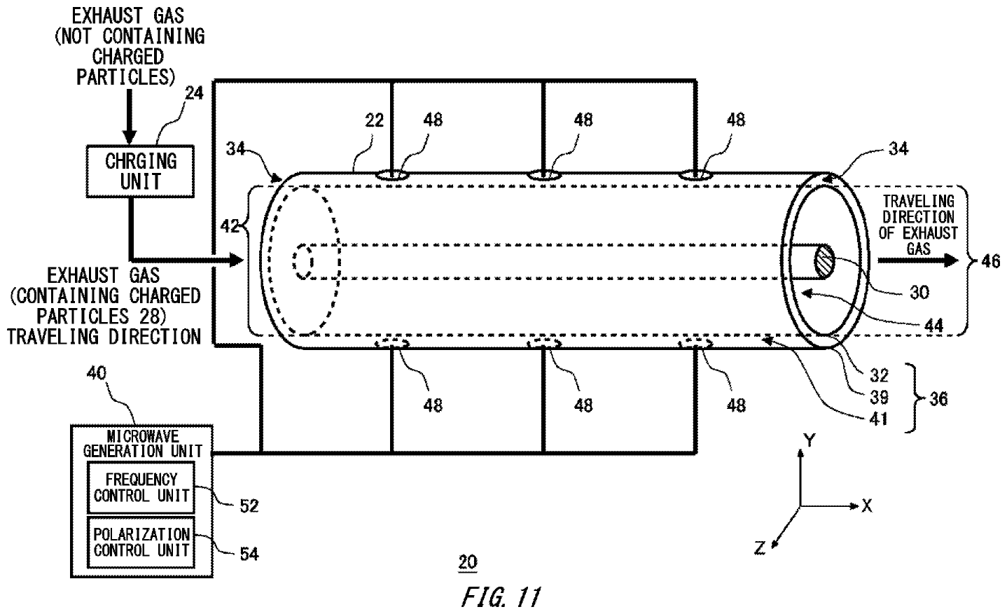

FIG. 11 shows an example of the electric dust collector 20 in accordance with one embodiment of the present invention. The electric dust collector 20 comprises the dust collection unit 22. In the present example, the dust collection unit 22 is cylindrical but may have another shape such as a box shape.

In the present example, the dust collection unit 22 has an opening 42 from which the exhaust gas is supplied, a gas flow path 44 through which the exhaust gas flows, and an opening 46 from which the exhaust gas is exhausted. The charged particles 28 may be generated by charging particles contained in the exhaust gas that is exhausted by a gas source. The gas source is, for example, the engine 60 (refer to FIG. 1). In the present example, the charging unit 24 charges particles contained in the exhaust gas exhausted by the gas source, thereby generating the charged particles 28. In the present example, the dust collection unit 22 traps the charged particles 28. The exhaust gas that is supplied to the opening 42 contains the charged particles 28 charged by the charging unit 24. The gas flow path 44 has a partition wall 32 surrounding a space in which a gas flows. The partition wall 32 may be cylindrical. The charged particles 28 are removed from the exhaust gas in the gas flow path 44. The exhaust gas from which the charged particles 28 have been removed is exhausted from the opening 46.

The dust collection unit 22 includes a charged particle accumulation unit 36 that accumulates the charged particles 28. In the present example, the charged particle accumulation unit 36 has a partition wall 32, a space 41 and an outer wall 39 in a YZ plane. The space 41 is arranged outside of the partition wall 32. The outer wall 39 is arranged outside of the space 41 in the YZ plane. The outer wall 39 may be cylindrical. Also, the partition wall 32 is provided with openings (which will be described later) for passing therethrough the charged particles 28. The partition wall 32 and the outer wall 39 may be formed of a metal material.

The outer wall 39 is applied with a potential for electrically sucking the charged particles 28. The potential that is applied to the outer wall 39 may be a ground potential. The charged particles 28 contained in the exhaust gas that passes through the gas flow path 44 pass the openings (which will be described later) of the partition wall 32 and are attached to the outer wall 39 of the charged particle accumulation unit 36, and the like. The charged particles 28 attached to the outer wall 39 and the like can be combusted by introducing the microwave into the space 41.

In the present example, the outer wall 39 has an opening 48 for introducing the microwave generated by the microwave generation unit 40. The outer wall 39 may have a plurality of the openings 48. In the present example, the traveling direction of the exhaust gas in the dust collection unit 22 is defined as the X-axis. The two orthogonal axes in a plane perpendicular to the X-axis are defined as the Y-axis and the Z-axis. The opening 48 may be arranged in plural along the X-axis direction. Also, the opening 48 may be arranged in plural along an outer periphery of the outer wall 39 in the YZ plane. In the example of FIG. 11, the two openings 48 are arranged with the gas flow path 44 being interposed therebetween in the Y-axis direction.

The dust collection unit 22 has reflection parts 34 for reflecting the microwave at both ends of the charged particle accumulation unit 36 in the X-axis direction. The reflection parts 34 provided at one end and other end in the X-axis direction may be provided to surround the space 41 in the YZ plane. The microwave introduced from the openings 48 propagates through the charged particle accumulation unit 36, is reflected by the reflection parts 34 and forms a traveling wave or standing wave in the charged particle accumulation unit 36.

The dust collection unit 22 has a first electrode 30 and a second electrode. The first electrode 30 may be arranged along a central axis of the dust collection unit 22. The first electrode 30 may have a rectangular rod shape in the X-axis. The first electrode 30 may be continuously provided from the opening 42 to the opening 46 along the X-axis direction. The second electrode may be arranged to surround the first electrode 30 in the YZ plane. In the present example, the partition wall 32 functions as the second electrode. The partition wall 32 may have a cylindrical shape in which the first electrode 30 is accommodated. The first electrode 30 may be arranged at a center of a region that is surrounded by the partition wall 32 in the YZ plane. In the YZ plane, the gas flow path 44 may be positioned between the first electrode 30 and the partition wall 32.

In the present example, the six openings 48 are provided. In the present example, the three openings 48 are aligned along the X-axis on each of one side and other side in a diametrical direction of the outer wall 39 in the YZ section. The microwave generated by the microwave generation unit 40 may be introduced into the six openings 48. The openings 48 are formed to penetrate the outer wall 39.

The microwave generation unit 40 may include at least one of a frequency control unit 52 that controls a frequency of the microwave and a polarization control unit 54 that controls a polarization direction of the microwave. In the present example, the microwave generation unit 40 includes both the frequency control unit 52 and the polarization control unit 54. The frequency control unit 52 and the polarization control unit 54 will be described later.

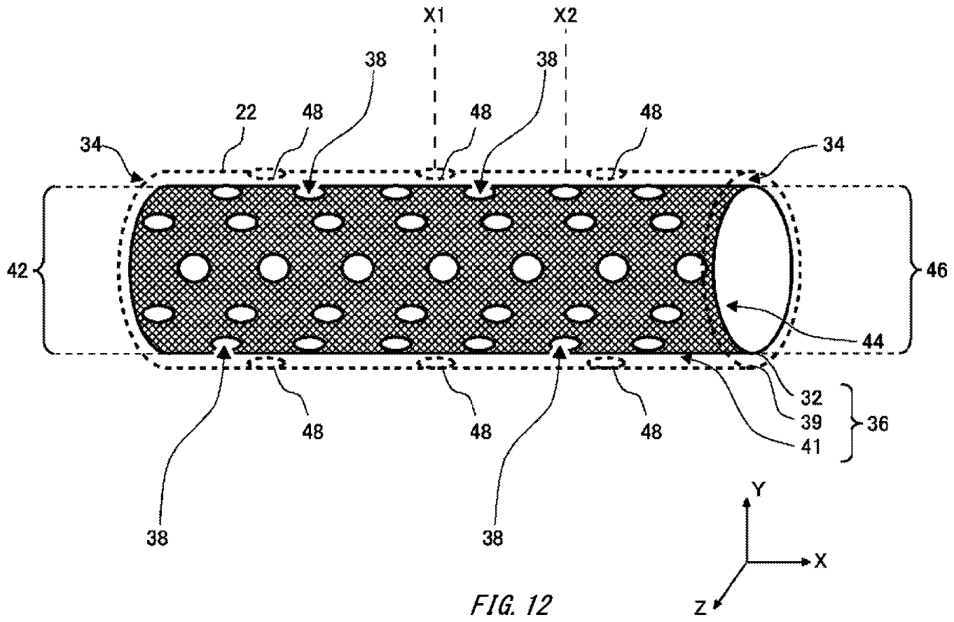

FIG. 12 shows an example of a configuration of the partition wall 32. In FIG. 12, the partition wall 32 is hatched. Also, in FIG. 12, the outer wall 39 is shown with the broken line. Also, in FIG. 12, the first electrode 30, the charging unit 24 and the microwave generation unit 40 are not shown.

The partition wall 32 has openings 38 through which the charged particles 28 pass. The opening 38 may be provided in plural. The openings 38 may be periodically provided in the X-axis direction and the YZ plane.

In the X-axis direction, positions of the openings 38 and positions of the openings 48 may be different. That is, when seeing the dust collection unit 22 from the +Y-axis direction toward the −Y-axis direction, the opening 48 and the partition wall 32 may overlap or the opening 48 and the partition wall 38 may not overlap. When seeing the dust collection unit 22 from the +Y-axis direction toward the −Y-axis direction, some of the openings 48 may overlap some of the openings 38.

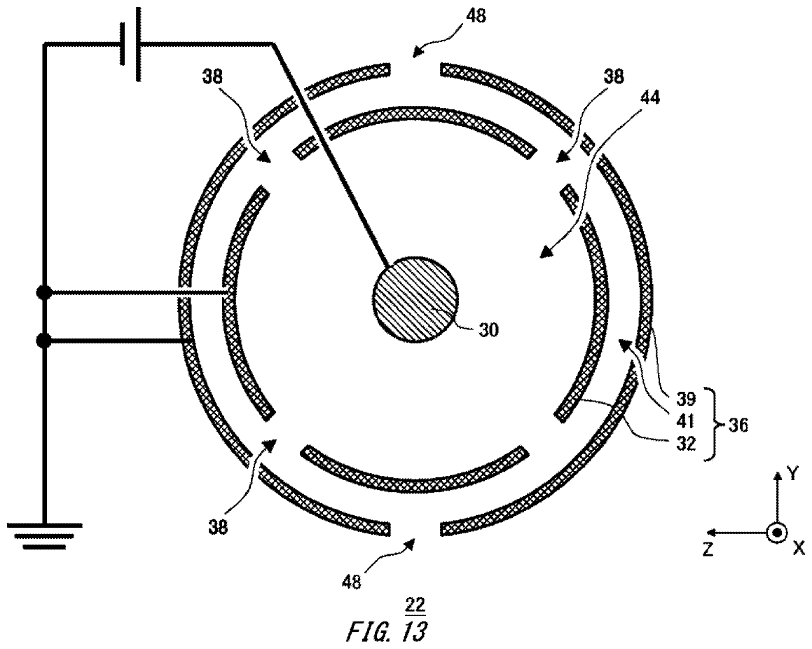

FIG. 13 shows an example of the YZ section in a position X1 in the X-axis direction of FIG. 12. The YZ section is a YZ plane passing the openings 48, the first electrode 30, the gas flow path 44, the partition wall 32, the openings 38, the space 41 and the outer wall 39. The YZ section is a section, when seeing the dust collection unit 22 shown in FIG. 12 from the +X-axis direction toward the −X-axis direction.

In a central position of the YZ section, the first electrode 30 is provided. The gas flow path 44 is provided around the first electrode 30. The gas flow path 44 is surrounded by the partition wall 32. The partition wall 32 is formed with the openings 38. The space 41 is provided outside of the partition wall 32. The space 41 is surrounded by the outer wall 39. The outer wall 39 is provided with the openings 48 for introducing the microwave. In the section of FIG. 13, the partition wall 32 is provided with the four openings 38, and the outer wall 39 is provided with the two openings 48.

The first electrode 30 may be set to a predetermined DC high potential with respect to the ground potential. The predetermined high potential is, for example, 10 kV. The partition wall 32 (second electrode) may be grounded. A predetermined DC high voltage (for example, 10 kV) is applied between the first electrode 30 and the partition wall 32.

When the predetermined DC high voltage is applied between the first electrode 30 and the partition wall 32 (second electrode), the first electrode 30 discharges. When the first electrode 30 discharges, the particles contained in the gas flowing between the first electrode 30 and the partition wall 32 are charged. The charged particles are attracted to the partition wall 32 and are moved into the space 41.

A position of an electric field that is generated by a potential difference between the first electrode 30 and the partition wall 32 (second electrode) and a position of an electric field that is applied by the microwave introduced from the openings 48 may be different. That is, a region to which an electric field for accumulating the charged particles 28 is applied and a region to which an electric field of the microwave for combusting the accumulated charged particles 28 is applied may be different. In the present example, the electric field for accumulating the charged particles 28 is applied from a center in a radial direction in FIG. 13 to a position of the partition wall 32 by the first electrode 30 and the partition wall 32 (second electrode). In contrast, the electric field of the microwave for combusting the charged particles 28 is applied between the partition wall 32 and the outer wall 39 in the radial direction in FIG. 13. The microwave propagates in the space 41 in the X-axis direction and in a circumferential direction in the YZ plane.

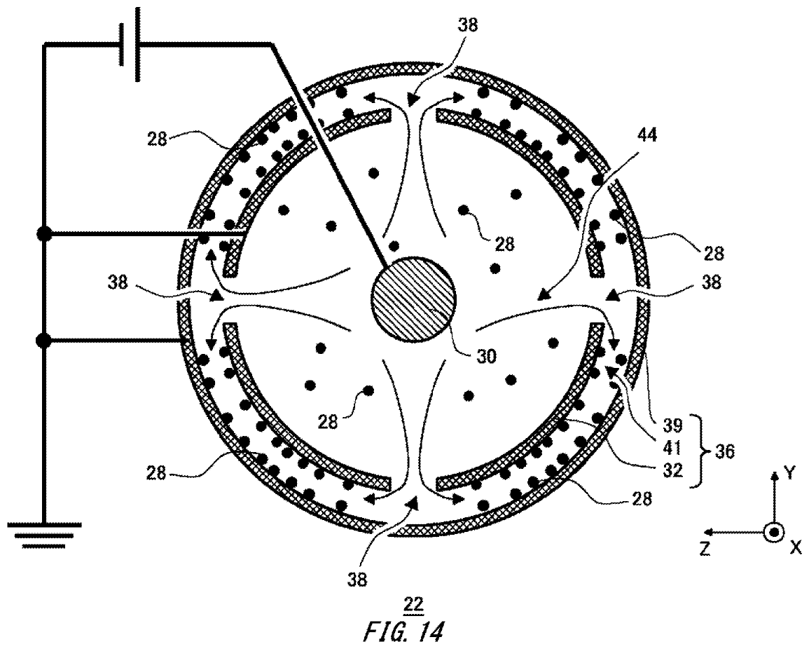

FIG. 14 shows an example of the YZ section in a position X2 in the X-axis direction of FIG. 12. The YZ section is a YZ plane passing the first electrode 30, the gas flow path 44, the partition wall 32, the openings 38, the space 41 and the outer wall 39. The YZ section is a section, when seeing the dust collection unit 22 shown in FIG. 12 from the +X-axis direction toward the −X-axis direction.

In the section of FIG. 14, the partition wall 32 is provided with the four openings 38. The two openings 38 are provided in positions facing in the Y-axis direction. The two other openings 38 are provided in positions facing in the Z-axis direction.

The charged particles 28 attracted to the partition wall 32 pass through the openings 38 and reach the space 41. The charged particles 28 are accumulated on an inner wall of the partition wall 32 and an inner wall of the outer wall 39, in the space 41. The charged particles 28 accumulated in the space 41 are combusted and decomposed by the microwave introduced from the openings 48.

In FIG. 14, as with FIG. 13, the position of the electric field that is generated by the potential difference between the first electrode 30 and the partition wall 32 (second electrode) and the position of the electric field that is applied by the microwave introduced from the openings 48 may be different. Also in FIG. 14, the microwave propagates in the space 41 in the X-axis direction and in the circumferential direction in the YZ plane.

The microwave generation unit 40 preferably generates intermittently the microwave. That is, the microwave generation unit 40 preferably generates the microwave at preset time intervals. As described above with reference to FIG. 7, when the microwave is intermittently irradiated to the charged particles 28, the charged particles 28 can be more efficiently combusted, as compared to when the microwave is continuously irradiated.

The microwave that propagates in the space 41 can combust the charged particles 28 most efficiently in the positions in which the electric field component of the microwave shows the maximum value (refer to FIG. 6). The charged particles 28 are likely to be equally accumulated on the inner wall of the partition wall 32 and the inner wall of the outer wall 39 in the space 41, in the X-axis direction and the YZ plane. The positions in the X-axis direction in which the electric field component of the microwave shows the maximum value can be changed by changing the frequency of the microwave. In the present example, since the microwave generation unit 40 includes the frequency control unit 52, it is possible to combust the charged particles 28 in the different positions in the X-axis direction by changing the frequency of the microwave that propagates in the space 41. For this reason, the electric dust collector 20 of the present example can combust and decompose the charged particles 28 accumulated in the space 41, irrespective of the accumulated positions in the X-axis direction.

Also, the microwave generation unit 40 of the present example includes the polarization control unit 54. The reflection and transmission of the microwave on the metal surface depend on the polarization direction of the microwave. For this reason, when the polarization direction of the microwave that propagates through the charged particle accumulation unit 36 is controlled to reduce the transmittance of the microwave in the openings 48 and the openings 38 by the polarization control unit 54, the microwave can be made into a traveling wave or standing wave even though the openings 48 and the openings 38 exist in the space 41.

In the space 41, circumferential positions (in the YZ plane) in which the electric field component of the microwave shows the maximum value can be changed by changing the polarization direction of the microwave. In the present example, since the microwave generation unit 40 includes the polarization control unit 54, it is possible to combust the charged particles 28 in the different positions in the YZ plane by changing the polarization direction of the microwave that propagates in the space 41. For this reason, the electric dust collector 20 of the present example can combust and decompose the charged particles 28 accumulated in the space 41, irrespective of the accumulated positions in the YZ plane.

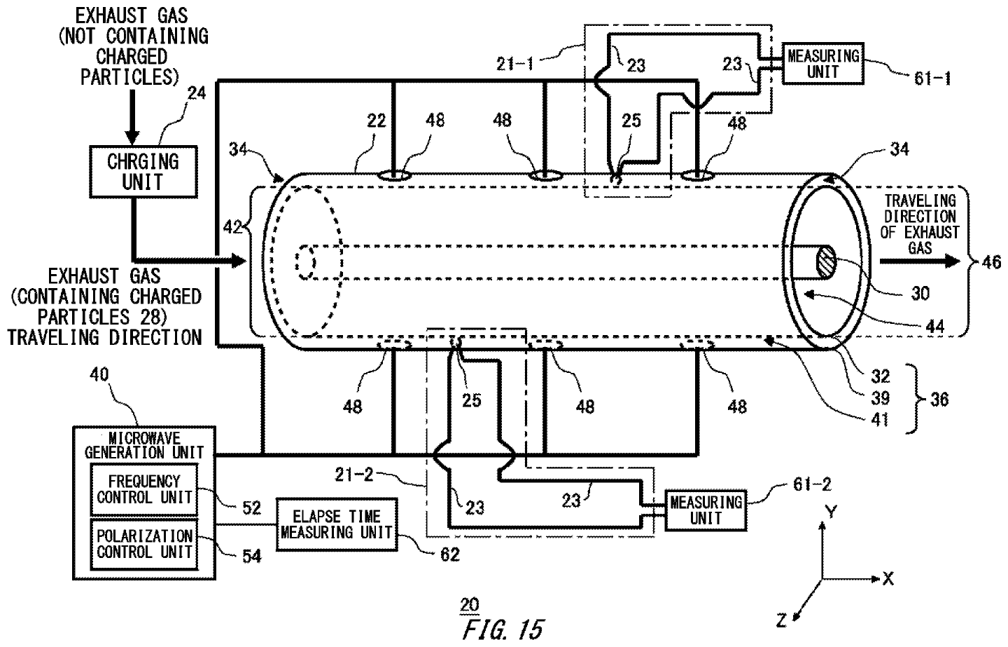

FIG. 15 shows another example of the electric dust collector 20 in accordance with one embodiment of the present invention. In the electric dust collector 20 of the present example, the dust collection unit 22 includes a temperature sensor 21. The temperature sensor 21 may measure a temperature of the charged particle accumulation unit 36. The dust collection unit 22 may include a plurality of the temperature sensors 21 arranged in different positions. In the present example, the dust collection unit 22 includes the two temperature sensors 21. The temperature sensor 21-1 is arranged on the opening 46-side in the X-axis direction. The temperature sensor 21-2 is arranged on the opening 42-side in the X-axis direction. The temperature sensors 21 are connected to the measuring unit 61.

In the present example, the temperature sensor 21 is a thermocouple. The temperature sensor 21 has a contact point 25 and a pair of metal lines 23. Each of the metal lines 23 interconnects the contact point 25 and the measuring unit 61. The measuring unit 61 may be a voltmeter. In the meantime, the temperature sensor 21 may be a PN diode, a thermistor or the like. The contact point 25 may be arranged at the charged particle accumulation unit 36. In the present example, when seeing the dust collection unit 22 in the X-axis direction, the contact point 25 of the temperature sensor 21-1 and the contact point 25 of the temperature sensor 21-2 are arranged in positions facing each other in the Y-axis direction.

In the space 41, when the charged particles 28 are combusted and decomposed by the irradiation of the microwave, the temperature of the charged particle accumulation unit 36 increases, and when the combustion and decomposition are over, the temperature of the charged particle accumulation unit 36 decreases. In the present example, since the electric dust collector 20 comprises the temperature sensors 21 at the charged particle accumulation unit 36, it is possible to measure a change in temperature accompanied by the combustion and decomposition of the charged particles 28.

The microwave generation unit 40 may generate the microwave, based on the temperature detected by the temperature sensors 21. When the temperature detected by the temperature sensors 21 decreases over time and a temperature in a predetermined low-temperature region becomes constant, the microwave generation unit 40 may start to generate the microwave. Also, when the temperature detected by the temperature sensors 21 increases over time and a temperature in a predetermined high-temperature region becomes constant, the microwave generation unit 40 may stop the generation of the microwave.

Also, in the present example, since the two temperature sensors 21 are provided in the different positions on the dust collection unit 22, the electric dust collector 20 can measure temperatures in two places on the dust collection unit 22. For this reason, as compared to a configuration where the dust collection unit 22 has one temperature sensor 21, it is possible to more easily generate and stop the microwave in accordance with the positions of the charged particles 28.

The microwave generation unit 40 may generate the microwave, based on a trapped state of the charged particles 28 trapped in the dust collection unit 22. In the present example, the electric dust collector 20 further comprises an elapsed time measuring unit 62. The elapsed time measuring unit 62 measures elapsed time after stopping the generation of the microwave. The trapped state of the charged particles 28 can be determined by the elapsed time, for example. For this reason, the microwave generation unit 40 may generate the microwave, based on the elapsed time.

The elapsed time after stopping the generation of the microwave may be elapsed time from time t3 in FIG. 8, for example. When time elapses from time t3 to time t4 in FIG. 8, for example, the microwave generation unit 40 may start to generate the microwave.

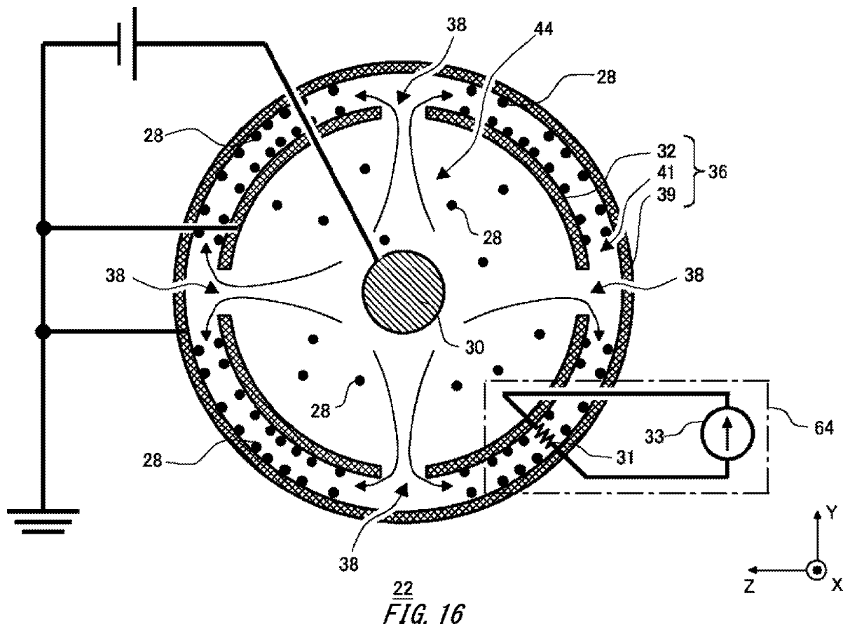

FIG. 16 shows another example of the YZ section in the position X2 in the X-axis direction of FIG. 12. In the present example, the electric dust collector 20 further comprises a particle amount measuring unit 64. In the present example, the particle amount measuring unit 64 includes a constant current source 33. The particle amount measuring unit 64 measures an amount of the charged particles 28, based on a resistance value (which is shown as a resistor 31 in FIG. 16) between the partition wall (second electrode) 32 and the outer wall 39. The constant current source 33 supplies constant current to the resistor 31. A resistance value of the resistor 31 varies, depending on an amount of the charged particles 28 attached on the partition wall 32 and the outer wall 39.

The microwave generation unit 40 may generate the microwave, based on the trapped state of the charged particles 28 trapped in the dust collection unit 22. In the present example, the trapped state of the charged particles 28 is an amount of the charged particles 28 measured by the particle amount measuring unit 64. When soot containing the charged particles 28 is accumulated in the charged particle accumulation unit 36, the resistance value indicated by the resistor 31 is lowered. For this reason, it is possible to measure an accumulated amount of the charged particles 28.

When the resistance value indicated by the resistor 31 decreases over time and becomes constant at a predetermined resistance value, the microwave generation unit 40 may start to generate the microwave. Also, when the resistance value indicated by the resistor 31 increases over time and becomes constant at a predetermined resistance value, the microwave generation unit 40 may stop the generation of the microwave.

The electric dust collector 20 may comprise a plurality of the particle amount measuring units 64. The electric dust collector 20 may comprise a plurality of the particle amount measuring units 64 in the YZ section of FIG. 16, or may comprise a plurality of the particle amount measuring units 64 in different positions in the X-axis direction. When the electric dust collector 20 comprises a plurality of the particle amount measuring units 64, it is possible to more easily generate and stop the microwave in accordance with the positions of the charged particles 28, as compared to a configuration where one particle amount measuring unit 64 is provided.

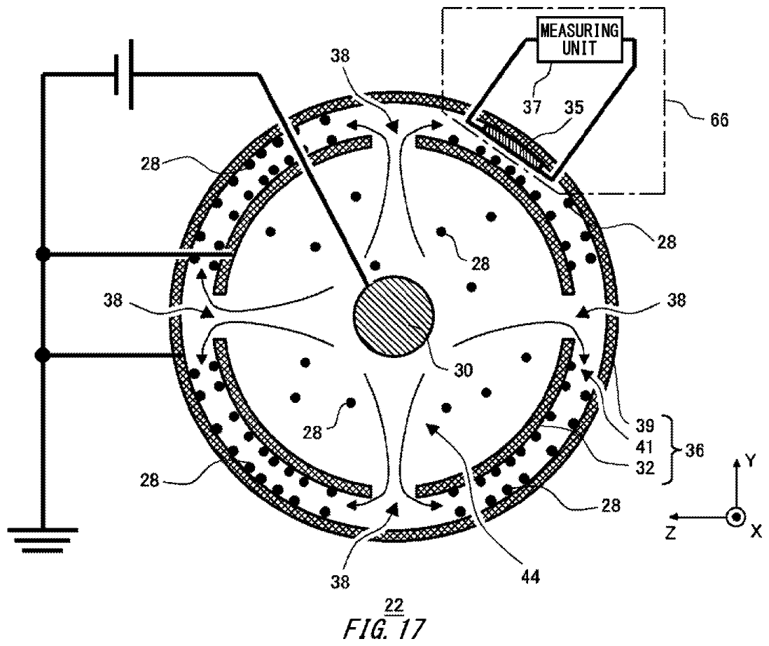

FIG. 17 shows another example of the YZ section in the position X2 in the X-axis direction of FIG. 12. In the present example, the electric dust collector 20 further comprises a concentration measuring unit 66. The concentration measuring unit 66 may measure a concentration of at least one of carbon dioxide (CO₂), oxygen (O₂) and carbon monoxide (CO). In the present example, the concentration measuring unit 66 includes a carbon dioxide (CO₂) gas sensor 35 and a measuring unit 37 that measures a concentration of carbon dioxide (CO₂) gas. The carbon dioxide (CO₂) gas sensor 35 may be provided in the charged particle accumulation unit 36.

The carbon dioxide (CO₂) gas sensor 35 is, for example, a solid electrolyte type carbon dioxide (CO₂) gas sensor having a substance that reacts with carbon dioxide (CO₂) gas and is provided in an electrode. The measuring unit 37 is, for example, a voltmeter. In this case, since a resistance value of the carbon dioxide (CO₂) gas sensor 35 is changed due to reaction with the carbon dioxide (CO₂) gas, when current is enabled to flow through the carbon dioxide (CO₂) gas sensor 35 and a potential difference between both ends of the carbon dioxide (CO₂) gas sensor 35 is measured by the measuring unit 37 (a voltmeter), the concentration of the carbon dioxide (CO₂) gas can be measured.

The microwave generation unit 40 may generate the microwave, based on the concentration of carbon dioxide (CO₂) measured by the concentration measuring unit 66. When the charged particles 28 are combusted and decomposed by the irradiation of the microwave, a carbon dioxide (CO₂) gas is generated. As shown in FIG. 8, the concentration of the carbon dioxide (CO₂) gas gradually decreases as the charged particles 28 are combusted and decomposed (from time t3 to t4 in FIG. 8). For this reason, when the concentration of carbon dioxide (CO₂) decreases over time and is eventually not detected, the microwave generation unit 40 may start to generate the microwave. Also, when the concentration of carbon dioxide (CO₂) increases over time and becomes constant at a predetermined concentration, the microwave generation unit 40 may stop the generation of the microwave.

The electric dust collector 20 may comprise a plurality of the concentration measuring units 66. The electric dust collector 20 may comprise a plurality of the concentration measuring units 66 in the YZ section of FIG. 16, or may comprise a plurality of the concentration measuring units 66 in different positions in the X-axis direction. When the electric dust collector 20 comprises a plurality of the concentration measuring units 66, it is possible to more easily generate and stop the microwave in accordance with the positions of the charged particles 28, as compared to a configuration where one the concentration measuring unit 66 is provided.

The microwave generation unit 40 may generate the microwave, based on a type of fuel that generates the charged particles 28. The fuel is fuel that is supplied to the engine 60 of FIG. 1. The exhaust gas of the engine 60 changes, in accordance with the type of the fuel that is supplied to the engine 60. For this reason, a component and an amount of the charged particles 28 that are trapped in the dust collection unit 22 may change, in accordance with the type of the fuel. For this reason, when at least one of the time interval at which the microwave is generated and the frequency and polarization of the microwave direction is controlled, in accordance with the type of the fuel, the charged particles 28 can be efficiently combusted and decomposed.

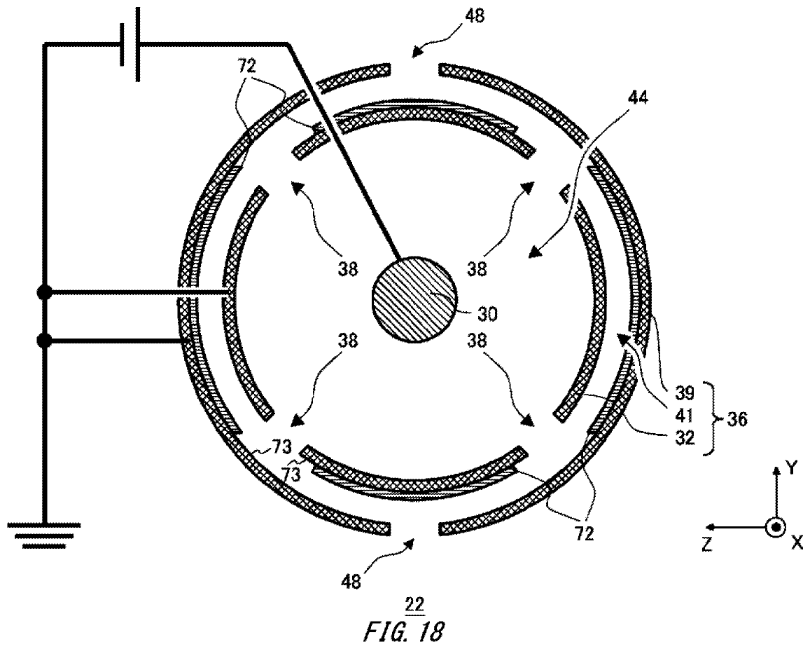

FIG. 18 shows another example of the YZ section in the position X1 in the X-axis direction of FIG. 12. In the present example, the dust collection unit 22 further includes a catalyst 72. The catalyst 72 promotes combustion of the charged particles 28 by the microwave. The catalyst 72 is, for example, zinc oxide (ZnO), cobalt oxide (CoO), tricobalt tetroxide (Co₃O₄), aluminum oxide (Al₂O₃), zirconium oxide (ZrO₂), lead zirconate titanate (PZT), or the like.

The catalyst 72 may be applied on inner walls 73 of the dust collection unit 22. In the present example, the catalyst 72 is applied on a wall surface on an outer side (the space 41-side) of the partition wall 32 (second electrode) and a wall surface on an inner side (the space 41-side) of the outer wall 39, in the YZ section.

The catalyst 72 may also be provided in a part of the dust collection unit 22. The catalyst 72 may also be applied to a part of the partition wall 32 (second electrode). In the charged particle accumulation unit 36, when the catalyst 72 is applied on the entire surface of the partition wall 32, the effect of promoting the combustion of the charged particles 28 is improved but the cost is increased due to an increase in use amount of the catalyst 72. Also, when the catalyst 72 is applied on the entire surface of the partition wall 32, the maintenance of the catalyst 72 requires more labor, as compared to when the catalyst is applied to a part. For this reason, the catalyst 72 is preferably applied to a part of the partition wall 32 in the charged particle accumulation unit 36. The catalyst 72 may be applied to a position of the partition wall 32 in which the charged particles 28 are difficult to be combusted and decomposed.

The catalyst 72 may be applied to a part of the partition wall 32 (second electrode) in the YZ section of FIG. 18. Also, the catalyst 72 may be applied to a part of the partition wall 32 (second electrode) in the X-axis direction.

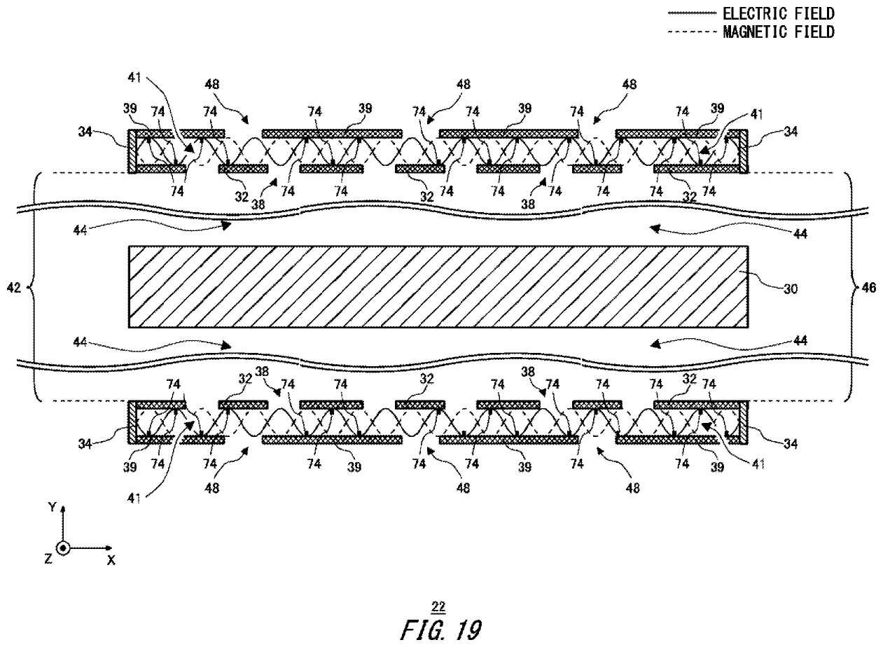

FIG. 19 shows an XY section passing the outer wall 39, the openings 48, the space 41, the openings 38, the first electrode 30 and the partition wall 32 (the second electrode) of the dust collection unit 22 in FIGS. 11 and 12. FIG. 19 is a sectional view of the XY section passing diameters of the opening 42 and the opening 46 in the Y-axis direction, as seen from the +Z-axis direction toward the −Z-axis direction. In FIG. 19, the microwave that propagates in the space 41 is pictorially shown.

The dust collection unit 22 may include soot accumulation units 74 that accumulate soot generated as a result of the combustion of the charged particles 28 by the microwave. The soot accumulation units 74 accumulate soot that is generated due to incomplete combustion of the fuel in the engine 60 (refer to FIG. 1). The soot contains the charged particles 28. For example, the soot accumulation unit 74 is a protrusion that is provided on a surface of at least one of the partition wall 32 (second electrode) and the outer wall 39 and protrudes into the space 41. The soot accumulation unit 74 may be formed of the same material as the partition wall 32 (second electrode) and the outer wall 39. The soot accumulation units 74 may be provided in an annular shape along a surface of the partition wall 32 (second electrode) in the YZ plane.

The soot accumulation units 74 may be periodically arranged along the traveling direction of the microwave (in the present example, the X-axis direction). The arrangement period of the soot accumulation units 74 may be the same as the period of the standing wave of the microwave. In the present example, the soot accumulation units 74 are arranged with the same period as the period of the microwave, on each of the partition wall 32 (second electrode) and the outer wall 39. The arrangement period of the soot accumulation units 74 is set to be the same as the period of the microwave, so that it is possible to accumulate the soot in the positions in which the electric field component of the microwave shows the maximum value. For this reason, it is possible to efficiently combust the charged particles 28. In the meantime, the soot accumulation unit 74 may be provided in a circular shape over the entire inner wall (the inner wall facing the space 41) of the partition wall 32 (second electrode) in the YZ plane.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An electric dust collector comprising:
a dust collection unit that traps charged particles; and
a microwave generation unit that generates a microwave to be introduced into the dust collection unit and combusts the charged particles trapped in the dust collection unit by the microwave.

2. The electric dust collector according to claim 1, wherein
the microwave generation unit includes a frequency control unit that changes a frequency of the microwave to combust the charged particles in different positions.

3. The electric dust collector according to claim 1, wherein
the microwave generation unit includes a polarization control unit that controls a polarization direction of the microwave.

4. The electric dust collector according to claim 1, wherein
the dust collection unit includes a first electrode and a second electrode,
the dust collection unit traps the charged particles by an electric field that is generated by a potential difference between the first electrode and the second electrode, and
in the dust collection unit, a position of the electric field that is generated by the potential difference between the first electrode and the second electrode and a position of an electric field that is applied by the microwave are different.

5. The electric dust collector according to claim 4, wherein
the second electrode is arranged around the first electrode,
the dust collection unit includes a charged particle accumulation unit that accumulates the charged particles,
the charged particle accumulation unit has an outer wall arranged around the second electrode,
the charged particles are moved into a space between the second electrode and the outer wall in the charged particle accumulation unit by the electric field that is generated by the potential difference between the first electrode and the second electrode, and
an electric field of the microwave is applied to the space.

6. The electric dust collector according to claim 1, wherein
the microwave generation unit intermittently generates the microwave.

7. The electric dust collector according to claim 6, wherein
the microwave generation unit can change a time interval at which the microwave is generated or an irradiation time of the microwave.

8. The electric dust collector according to claim 7, wherein
the microwave generation unit sets a pulse width of the microwave that is generated in a state where the charged particles are continuously combusting smaller than a pulse width of the microwave that is generated in a state where the charged particles are not continuously combusting.

9. The electric dust collector according to claim 6, wherein
the microwave generation unit can change an output of the microwave.

10. The electric dust collector according to claim 9, wherein
the microwave generation unit sets an amplitude of the microwave that is generated in a state where the charged particles are continuously combusting smaller than an amplitude of the microwave that is generated in a state where the charged particles are not continuously combusting.

11. The electric dust collector according to claim 6, wherein
the microwave generation unit generates the microwave, based on a trapped state of the charged particles trapped in the dust collection unit.

12. The electric dust collector according to claim 11, further comprising an elapsed time measuring unit that measures an elapsed time after stopping generation of the microwave, wherein
the microwave generation unit generates the microwave, based on an elapsed time measured by the elapsed time measuring unit.

13. The electric dust collector according to claim 11, further comprising a particle amount measuring unit that measures an amount of the charged particles trapped in the dust collection unit, wherein
the microwave generation unit generates the microwave, based on an amount of the charged particles measured by the particle amount measuring unit.

14. The electric dust collector according to claim 6, wherein
the charged particles are generated by charging particles contained in an exhaust gas that is exhausted by a gas source,
the dust collection unit traps the charged particles, and
the microwave generation unit generates the microwave, based on a type of fuel of the gas source.

15. The electric dust collector according to claim 6, wherein
the dust collection unit includes a temperature sensor that detects a temperature of the dust collection unit, and
the microwave generation unit generates the microwave, based on a temperature detected by the temperature sensor.

16. The electric dust collector according to claim 15, wherein
the dust collection unit includes a plurality of the temperature sensors arranged in different positions, and
the microwave generation unit generates the microwave, based on temperatures detected by the plurality of the temperature sensors.

17. The electric dust collector according to claim 6, further comprising a concentration measuring unit that measures a concentration of at least one of carbon dioxide, oxygen and carbon monoxide in the dust collection unit, and
the microwave generation unit generates the microwave, based on the concentration measured by the concentration measuring unit.

18. The electric dust collector according to claim 1, wherein
the dust collection unit further includes a catalyst for promoting combustion of the charged particles by the microwave.

19. The electric dust collector according to claim 18, wherein
the catalyst is applied on an inner wall of the dust collection unit.

20. The electric dust collector according to claim 1, wherein
the dust collection unit further includes soot accumulation units that accumulate soot generated as a result of combustion of the charged particles by the microwave, and
the soot accumulation units are periodically arranged along a traveling direction of the microwave.
